(19) United States
(12) Patent Application Publication
(10) Pub. No.: US 2005/0208192 A1
(43) Pub. Date: Sep. 22, 2005

(54) Beverage base

(76) Inventors: Keith Nakakura, Brisbane, CA (US); Rhondi Shigemura, San Francisco, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 10/803,600

(22) Filed: Mar. 17, 2004

(51) Int. Cl. A23L 1/216

(52) U.S. Cl. 426/580

(57) ABSTRACT

Beverage bases, a method for making beverage bases, and beverages made using beverage bases are described. These beverage bases may or may not require refrigeration and/or have a reduced calorie, carbohydrate, and sugar content.

### BACKGROUND OF THE INVENTION

1. Field of the Invention

The present invention is directed towards beverage bases, a method for making beverage bases, and beverages made using beverage bases. More specifically, the present invention relates to beverage bases which may or may not require refrigeration and/or have a reduced calorie, carbohydrate, and sugar content.

2. Description of Related Art

Pre-packaged beverage bases and standardized preparation procedures allow a beverage to be created at the point of sale with uniformity and repeatability. However, such beverage bases are perishable for certain beverages such as blended fruit drinks or dairy-based beverage bases.

Also, certain beverage bases may have a high caloric content due to the use of sweeteners such as corn syrup and sugar.

What is needed is a beverage base that does not need to be refrigerated. What is also needed is a beverage base with a reduced calorie content that can produce a finished beverage with a reduced calorie, carbohydrate, and/or sugar content.

### BRIEF DESCRIPTION OF THE DRAWINGS

FIGS. 1-3 show various embodiments of blender speed profiles of the present invention.

### DETAILED DESCRIPTION OF THE INVENTION

The present invention is directed towards beverage bases, a method for making the beverage bases, and beverages made using the beverage bases.

The beverage base may be comprised of dairy ingredients such as nonfat dry milk, sweet whey, and/or whey protein. The base may also be comprised of non-dairy ingredients such as soy milk, soy protein, and/or caesin. The beverage base also includes a sweetener. The beverage base may also include a stabilizer, flavoring, and coloring.

The sweetener may be a nutritive sweetener, such as lohan or stevia extract, or a non-nutritive sweetener, such as aceylfame K, neotame, aspartame, saccharin, or a sugar alcohol such as xylitol, sorbitol, mannitol, lactitol, maltitol, trehalulose, isomalt, erythritol, or other polyols. The sweetener is preferably a low-calorie or non-caloric sweetener which reduces the number of calories in the beverage base and in the final finished beverage.

The stabilizer may include sodium citrate, sodium hexametaphosphate, carrageenan, pectin, alginates, and/or maltodextrin, starches or gums.

The flavoring may be vanilla or other natural or artificial flavor such as vanillin, ethyl vanillin, sweet flavors, or sweetness potentiating flavors.

The coloring may be annatto, tumeric, anthocyanin, or saffron extracts.

The beverage base is made by mixing the ingredients and then pasteurizing the product under aseptic processing conditions.

To prepare the beverage, various ingredients such as fruit, fruit juice, ice, and/or sherbet are added to the beverage base and blended or mixed. Other blended frozen, ambient or hot beverages may benefit from the use of such base to reduce caloric, carbohydrate or sugar content.

### EXAMPLE 1

The following is one example of a beverage base of the present invention:

| Ingredients | % |
|---|---|
| Water | 88.52 |
| Grade A nonfat dry milk | 8.08 |
| Grade A whey | 2.04 |
| Grade A whey protein concentrate | 0.21 |
| Sucralose | 0.03 |
| Stabilizer: | 0.70 |
| Sodium citrate | |
| Sodium hexametaphosphate | |
| Carrageenan | |
| Pectin | |
| Sodium alginate | |
| Maltodextrin | |
| Vanilla flavor | 0.41 |
| Annatto | 0.01 |

This formulation may also be manufactured in more concentrated forms by reducing the amount of water used:

| | Formulation | | | |
|---|---|---|---|---|
| | 1:1 | 2:1 | 3:1 | 4:1 |
| Ingredients | % | % | % | % |
| Water | 77.04 | 65.56 | 54.08 | 42.60 |
| Grade A nonfat dry milk | 16.16 | 24.24 | 32.32 | 40.40 |
| Grade A whey | 4.08 | 6.12 | 8.16 | 10.20 |
| Grade A whey protein concentrate | 0.42 | 0.63 | 0.84 | 1.05 |
| Sucralose | 0.06 | 0.09 | 0.12 | 0.15 |
| Stabilizer: | 1.40 | 2.10 | 2.80 | 3.50 |
| Sodium citrate | | | | |
| Sodium hexametaphosphate | | | | |
| Carrageenan | | | | |
| Pectin | | | | |
| Sodium alginate | | | | |
| Maltodextrin | | | | |
| Vanilla flavor | 0.82 | 1.23 | 1.64 | 2.05 |
| Annatto | 0.02 | 0.03 | 0.04 | 0.05 |

The ingredients are mixed in a mix tank and pasteurized under aseptic processing conditions, i.e. aseptic manufacturing, aseptic packaging, and pasteurized product. This manufacturing process results in a beverage base that is pasteurized and shelf-stable. The beverage base is then packaged in shelf-stable packaging such as that available from Tetra Pak International SA. This facilitates distribution of the beverage base to the end user.

### EXAMPLE 2

The following is an example of a beverage made from the beverage base described in EXAMPLE 1.

Approximately four parts of fruit juice, five parts of fruit, and one part of ice are mixed with approximately eight parts of the beverage base. Fruits such as strawberries, bananas, blueberries, peaches, mangos, or raspberries, fruit juices such as apple, mango-passion fruit, peach, pineapple, raspberry, kiwi or cranberry, soymilk, or other milk, sherbets or other dairy ingredients such as frozen or fresh yogurt, and other may be used.

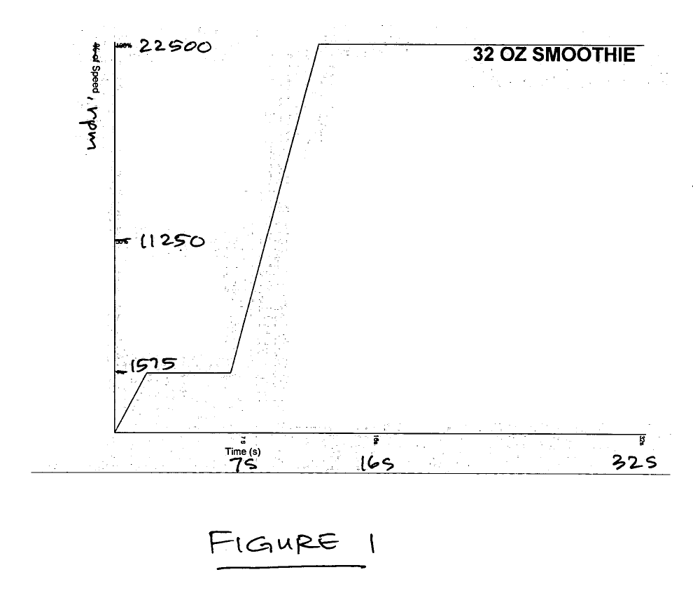

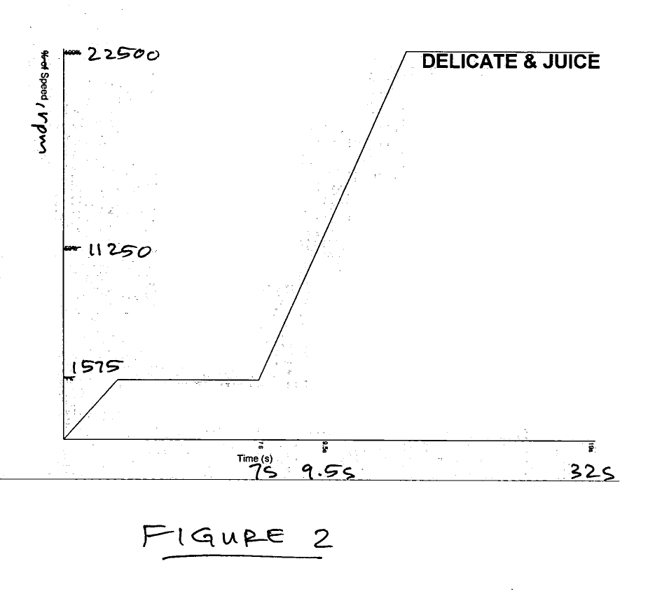

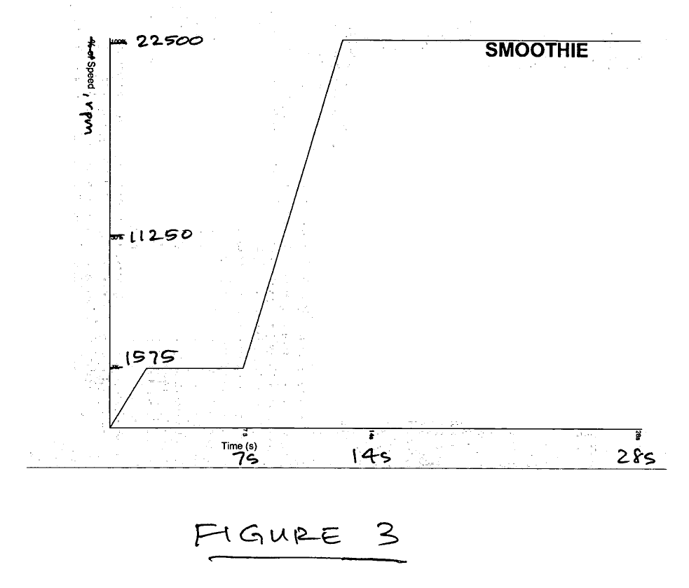

FIGS. 1-3 show various embodiments of blender speed profiles of the present invention. The blender speeds profiles may consist of mixing the components at a lower speed of 1000-2000 rpm for 5-10 seconds, followed by mixing at a higher speed of 20000-30000 rpm for 10-30 seconds. This blender profile provides an ideal amount of mixing and aeration, while giving the beverage a desirable consistency.

While the invention has been described in terms of some specific examples and in some specific embodiments, it will be clear that this invention is not limited to these specific examples and embodiments and that many changes and modified embodiments will be obvious to those skilled in the art without departing from the true spirit and scope of the invention as defined in the appended claims.

1. A beverage mix comprising:
40-90% water;
10-50% dairy base;
0.5-4% stabilizer;
0.02-1.0% non-nutritive sweetener;
0.3-10% flavoring; and
0.01-02% coloring.

2. The beverage mix of claim 1, wherein the dairy base includes 8-9% nonfat dry milk, 2-3% whey, and 0.10-0.30% whey protein concentrate.

3. The beverage mix of claim 1, wherein the sweetener is sucralose.

4. The beverage mix of claim 1, wherein the flavoring is vanilla.

5. The beverage mix of claim 1, wherein the coloring is annatto.

6. A method for preparing a beverage mix, the method comprising:
mixing approximately eight parts of the beverage base of claim 2 with approximately four parts of fruit juice, five parts of fruit, and one part of ice in a blender at 1000-2000 rpm for 5-10 seconds, followed by mixing at 20000-30000 rpm for 10-30 seconds.
